(19) United States
(12) Patent Application Publication
(10) Pub. No.: US 2011/0282040 A1
(43) Pub. Date: Nov. 17, 2011

(54) PREPARATION OF FUNCTIONALIZED ORGANOSILICON COMPOUNDS IN A BIPHASE MEDIUM

(75) Inventors: Thierry Vidal, Lyon (FR); Virginie Pevere, Lyon (FR)

(73) Assignee: RHODIA OPERATIONS, Aubervilliers (FR)

(21) Appl. No.: 12/935,056

(22) PCT Filed: Apr. 3, 2009
(86) PCT No.: PCT/EP2009/054029

§ 371 Date: May 31, 2011

(30) Foreign Application Priority Data
Apr. 4, 2008 (FR) 08 01878

(51) Int. Cl. C07F 7/18; C07F 7/20; C07F 7/10

(52) U.S. Cl. 534/586; 534/726

(57) ABSTRACT

Functionalized organosilicon compounds (I), including at least one azo-activated structural unit, are prepared by: A. reacting at least one silane precursor (IV) with at least one hydrazo-precursor compound (V) to obtain hydrazine precursors (II) of such organosilicon compounds and B. oxidizing the hydrazine group of the precursors (II) to obtain precursors of the compounds (I), employing an oxidizer (NaOCl) and a base (NaOH), the oxidation being carried out in a biphase aqueous/organic medium, with the pH of the aqueous phase ranging from 3 to 11, such oxidation B being carried out directly in the reaction medium obtained from step A and containing the precursors (II), without isolating these precursors.

The field of the invention is that of the synthesis of functionalized organosilicon compounds.

The organosilicon compounds to which the invention more especially relates are those comprising at least one activated azo group. This activation can result, for example, from the presence of carbonyl groups neighboring the nitrogen. The organosilicon part of these compounds may in particular comprise hydrolysable or condensable groups of ≡SiOR or ≡SiOH type.

Such organosilicon compounds comprising available activated azo group(s) (for instance those comprising a —CO—N═N—CO— group) are very useful, in particular in the synthesis of active organic molecules (in particular nitrogenous heterocycles) that can be used in the agrochemistry and pharmacy fields, for example as dienophiles in hetero-Diels-Alder reactions. Another possible application of these organosilicon compounds is as a white filler-hydrocarbon-based polymer coupling agent, in particular white filler-elastomer coupling agent. The coupling agent aims to provide an efficient bond between the polymer (elastomer) and this white filler, which may be a siliceous material (such as a precipitated silica, a silicate or a clay), as a reinforcing filler, and which may be intended to give the polymer tensile strength and abrasion resistance.

Application WO 2006/125888 discloses a synthesis of functionalized organosilicon compounds comprising at least one activated azo group (—N═N—), of formula (I′), which consists in oxidizing a hydrazino (—HN—NH—) precursor (II′), using an oxidizing system comprising at least one oxidizing agent (bromine or bleach NaOCl) and at least one base (NaOH or K₂HPO₄), this oxidation being carried out in an aqueous/organic two-phase medium (pH of the aqueous phase maintained between 3 and 11). The reaction scheme is the following:

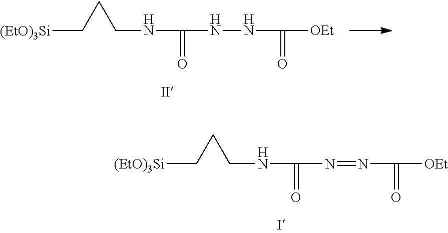

This application WO 2006/125888 also discloses a method for preparing compounds (I′), comprising the following steps:

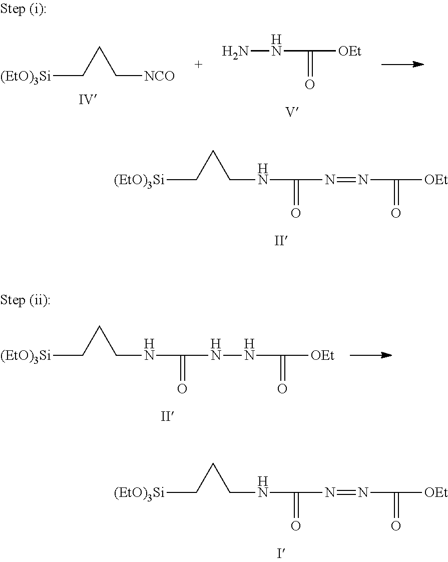

These steps (i) and (ii) are described in detail as follows in application WO 2006/125888:
Step (i):
Putting to use the precursor hydrazo derivative (V′) and the solvent (toluene), at ambient temperature in the reactor, under an inert atmosphere.
Stirring at several hundred rpm and heating to a temperature of 40-100° C.
Addition of the precursor silane of formula (IV') over several tens of minutes.
Reaction for several hours with stirring at a temperature of 40-100° C. before a return to ambient temperature.
Leaving to stand for several hours at ambient temperature.
Recovery of the solid precursor (II′) (for example), filtration, washing, drying.
Step (ii):
Putting to use the precursor (II′), the organic solvent, the aqueous buffer and/or water and/or adjuvant (pyridine) at ambient temperature in the reactor, under an inert atmosphere.
Addition of the oxidizing agent (bromine or NaOCl) and of a base (NaOH or K₂HPO₄) to the reactor simultaneously, in small amounts (in particular dropwise) and very slowly (a few minutes to several hours, for example over 0.5 to 2 hours), at a temperature below 30° C., preferably at ambient temperature.
Stirring at ambient temperature for several hours.
Extraction of the aqueous phase and combining together of the organic phase.
Separation of the organic phase.
Optionally, drying (over MgSO₄).
Optionally, filtration.
Concentration.
Recovery of the organosilicon compound comprising an activated azo group (I′).

Steps (i) and (ii) of this method are discontinuous. Step (i) ends with the recovery by filtration of the precursor (II′), which is a solid. Step (ii) begins with putting to use (mixing) the recovered precursor (II′), the organic solvent, the aqueous buffer and/or water and/or adjuvant (pyridine) in a reactor which does not contain the reaction medium obtained at the end of step (i). These two steps (i) and (ii) are not linked. This discontinuity is not desirable from an industrial point of view. This is because the recovery operation and the handling of the precursor (II′) recovered from step (i), in step (ii), are sources of time loss, energy loss and loss of precursor (II′). This puts a strain on the economics of the method. It can also be specified that the handling of the precursor (II′), which is solid, can be dangerous: risk of dust explosion and exposure of operators to the product.

Given this prior art, one of the essential objectives of the present invention is to propose a method for preparing organosilicon compounds comprising one or more azo group(s) (I), by formation of a hydrazino precursor (II) and by oxidation of the hydrazino group of this precursor (II) to an azo group, this method advantageously improving the method comprising steps (i) and (ii) according to application WO 2006/125888 and remedying the drawbacks specific to this known method.

Another essential objective of the invention is to provide a method for preparing organosilicon compounds (I) comprising one or more azo group(s), which is effective, in particular more effective than those of the prior art, in particular in terms of productivity and yield of intended azoalkoxysilane.

Another essential objective of the invention is to provide a method for preparing organosilicon compounds (I) comprising one or more azo group(s), which are stable, in particular at high temperatures, for example between 80 and 180° C. (in particular, differential scanning calorimetry, DSC, stability).

Another essential objective of the present invention is to provide an economical method for preparing organosilicon compounds (I) comprising one or more azo group(s).

Another essential objective of the invention is to provide a method for preparing organosilicon compounds comprising one or more azo group(s), which can make it possible to optimize the quality of the products obtained, in particular with regard to the purity of these compounds, and especially by reducing to trace amounts, or even eliminating, undesirable residues, in particular in connection with the performance levels required in applications and with industrial and environmental hygiene.

These objectives, among others, are achieved by the invention, which relates, first of all, to a method for preparing organosilicon compounds comprising one or more compounds which may be identical to or different than one another, of azosilane type of formula (I):

Y—X—CO—N═N—CO—X¹—Z (I)
in which:
X is
an amine group —NR°, with R° representing a hydrogen atom (H), a linear, branched or cyclic alkyl group containing from 1 to 20 carbon atoms, an aryl group containing from 6 to 18 carbon atoms, or an arylalkyl or alkylaryl group (C₆-C₁₈ aryl, C₁-C₂₀ alkyl), this alkyl, aryl, arylalkyl or alkylaryl group being substituted or unsubstituted,
an oxygen atom,
a sulfur atom,
a covalent bond,
or a substituted or unsubstituted, linear, branched or cyclic alkylene group containing from 1 to 20 carbon atoms;
X¹ is
an amine group —NR°, with R° representing a hydrogen atom (H), a linear, or cyclic alkyl group containing from 1 to 20 carbon atoms, an aryl group containing from 6 to 18 carbon atoms, or an aralkyl group (C₆-C₁₈ aryl, C₁-C₂₀ alkyl), this alkyl, aryl or aralkyl group being substituted or unsubstituted,
an oxygen atom,
a sulfur atom,
or a substituted or unsubstituted, linear, branched or cyclic alkylene group containing from 1 to 20 carbon atoms;
Y is a linear, branched or cyclic alkyl group containing from 1 to 20 carbon atoms, an aryl group containing from 6 to 18 carbon atoms, or an arylalkyl or alkylaryl group (C₆-C₁₈ aryl, C₁-C₂₀ alkyl), this alkyl, aryl, arylalkyl or alkylaryl group being substituted or unsubstituted or being the same as Z and optionally bearing at least one heteroatom (for example O, N or S); and
Z is a linear, branched or cyclic alkyl group containing from 1 to 20 carbon atoms, an aryl group containing from 6 to 18 carbon atoms, or an arylalkyl or alkylaryl group (C₆-C₁₈ aryl, C₁-C₂₀ alkyl), this alkyl, aryl, arylalkyl or alkylaryl group being substituted with at least one polyorganosiloxane group and/or at least one silane group, corresponding to the formula:

—SiR¹ₐ(OR²)_{b}(OSiR³R⁴R⁵)_{c}
in which:
a, b and c are integers selected such that a+b+c=3;
R¹, R², R³, R⁴ and R⁵ are, independently of one another, a linear, branched or cyclic alkyl group containing from 1 to 20 carbon atoms, an aryl group containing from 6 to 18 carbon atoms, or an arylalkyl or alkylaryl group (C₆-C₁₈ aryl, C₁-C₂₀ alkyl), this alkyl, aryl, arylalkyl or alkylaryl group being substituted or unsubstituted and optionally bearing at least one heteroatom;
   this method being characterized in that it is of the type of those which consist essentially
A. in reacting at least one precursor silane of formula (IV):

Z-L¹ (IV)
with at least one precursor hydrazo derivative of formula (V):

L²-NH—NH—CO—X—Y (V)
in which formulae the symbols Z, X and Y are as defined above, and L¹ and L² represent groups of which the structure and the functionality are such that these groups are capable of reacting with one another so as to give rise to the central series —Z—X¹—CO— in such a way as to result in products of formula (II), which are precursors of the compounds (I):

Y—X—CO—NH—NH—CO—X¹—Z (II)
B. then in oxidizing the hydrazino group of the precursors (II) to an azo group specific to the organosilicon compounds comprising one or more activated azo group(s) (I), using an oxidizing system comprising at least one oxidizing agent (Ox) and at least one base (B), this oxidation being carried out in an aqueous/organic two-phase medium, the pH of the aqueous phase being between 3 and 11, preferably between 5 and 9;
   and in that the oxidation step B is carried out directly in the reaction medium obtained at the end of step A and containing the precursors (II).

Thus, in accordance with an advantageous mode of the invention, steps A and B are linked together. For the purpose of the invention, the expression “linked together” signifies, for example, that as soon as they have been formed by condensation of (IV) and (V), the precursors (II) can be subjected to the oxidation B and that the latter can take place 60 minutes at the latest (preferably 30 minutes) after the end of the condensation of (IV) and (V), the end of the condensation being understood, for example, to be the moment when the reaction equilibrium is reached.

According to another preferred mode of the invention, the precursors (II) produced at the end of step A are not isolated (extracted, for example, by filtration) from the reaction medium obtained at the end of step A.

These new arrangements are particularly advantageous in terms of industrialization of the method, since they limit the number of operations and handlings and, consequently, enable significant time and energy savings. They also limit the losses of precursors (II) and improve the safety of individuals and of the material.

Against all expectations, firstly, the impurities generated in step A of condensation of (IV) and (V) do not impair the oxidation B and, secondly, the conditions of this oxidation step B (the most restricting step), which can be implemented right from the beginning of the method and which are therefore imposed with step A (concentration, nature of the solvent, etc.), prove to be compatible with the step A. It in fact appears that the overall performance level obtained over the two steps A and B is greater than the product of the performance levels of the two steps separately. The performance levels considered here are, for example, 83% for the two steps separately and 88% for the two steps linked together (as is illustrated in the examples hereinafter).

By way of examples of L¹ and L² groups, mention may in particular be made of: L¹: NCO and L²: H;

### L¹: NH₂ and L²: Cl—CO.

The method according to the invention can be carried out according to a continuous or batchwise mode.

The term “continuous mode” denotes, for example, the linking together of steps A and B without isolation of the intermediate (II).

The term “batchwise mode” denotes, for example, the performing of reaction steps A and B sequentially with isolation of the intermediate (II) at the end of step A.

The oxidation B is carried out in an aqueous/organic two-phase medium and care is taken to ensure that the pH of the aqueous phase is between 3 and 11, preferably between 5 and 9. Procedures are generally carried out in this way in a water/organic solvent two-phase medium. The conversion of the precursors (II) to organosilicon compounds comprising one or more active azo group(s) (I) is carried out in the organic phase, whereas the aqueous phase solubilizes the various water-soluble compounds generated by the conversion. Moreover, ionic compounds, in particular acids, are known to be particularly well soluble in an aqueous phase. Thus, it is preferable to envision the use of an aqueous phase of which the pH remains between 3 and 11 during the reaction, and preferably between 5 and 9. For example, it may be advantageous to use an aqueous solution of which the pH remains close to neutrality (pH of approximately 7) during the reaction.

The method according to the invention improves the prior art by making it possible to do away with the very laborious industrial constraints linked to the use of anhydrous conditions and/or of a filtration step and/or of a solid reactant.

Furthermore, it makes it possible to control parasitic hydrolysis/condensation reactions. This notably limits the formation of oligomers and makes it possible to preserve optimal application properties for the targeted organosilicon compounds comprising one or more active azo group(s) (I).

In addition, advantageously, these compounds (I) obtained (directly) by means of the method according to the invention are remarkably pure. In particular, these compounds contain little (undetectable traces) or no undesirable residues, such as pyridine residues.

Without wishing to be bound by any theory, it is possible that this purity is responsible for the excellent stability noted for these compounds (I) derived from the two-phase method according to the invention. The “stability” is especially intended to mean storage stability, in particular under humid conditions, but especially heat stability.

One of the means recommended according to the invention for controlling, as required, the pH of the aqueous phase consists of the use of at least one buffer system and/or of the addition of at least one base and/or of at least one acid.

Advantageously, the buffer system can be selected from the group consisting of phosphate buffers, borate buffers and carbonate buffers, and mixtures thereof.

In accordance with the invention, the oxidizing agent (Ox) should be selected from oxidizing agents capable of oxidizing a hydrazo function to an azo function.

Preferably, the oxidizing agent (Ox) is selected from the group consisting of:
(Ox1): aqueous halogenated oxidizing agents, for example sodium hypobromite (NaOBr) and/or sodium hypochlorite (NaOCl) and/or tert-butyl hypochlorite;
(Ox2): anhydrous halogenated oxidizing agents, for example Cl₂ and/or Br₂ and/or N-bromosuccinimide and/or cyanide-containing halogenated (in particular chlorinated) compounds, especially trichloroisocyanuric acid;
(Ox3): all other oxidizing agents different than (Ox1) and than (Ox2), for example aqueous hydrogen peroxide solution; and
(Ox4): mixtures thereof.

The oxidizing agents of (Ox1) type are the preferred oxidizing agents in accordance with the invention. They are both oxidizing agents and bases capable of neutralizing, as required, the acidity that they are capable of generating by association of their halogen with an H+. These (Ox1) oxidizing agents do not therefore require the use of an additional base.

When the reaction is carried out in the presence of an anhydrous halogenated oxidizing agent (Ox2), the conversion of the hydrazo function (NH—NH) to an azo function (N═N) is accompanied by the release of one or two equivalents of acid (for example, HCl or HBr).

Under these conditions, preferably, the control of the pH in order to maintain it within the targeted range supposes, in accordance with the invention, recourse in particular to at least one of the following operating modes (among others):

a. using a buffered aqueous phase of desired pH and adding an amount of base)(B°) at the same time as the oxidizing agent (Ox2) in order to neutralize the acid released by the reaction;
b. and/or using an unbuffered aqueous phase and adding a base (B¹), with the nature of said base and the amount being selected in such a way as to form a buffer solution of pH which is adjusted during the reaction.

In mode a., the base B° is preferably run in substantially at the same time as the oxidizing agent (Ox2), and preferably gradually.

For example, in practice, (B°) and (Ox) are added simultaneously, in small amounts (in particular dropwise) and very slowly (a few minutes to several hours, for example over 0.5 to 2 hours) to the reaction mixture.

According to a preferred mode, the oxidizing agent(s) (Ox) is (are) used in stoichiometric amounts relative to the precursor (II).

According to one recommendable practical arrangement, the reaction is then carried out in the reaction medium, preferably kept stirring and at ambient temperature, for several hours (for example from 2 to 4 hours) after the end of the addition of the oxidizing agent (Ox).

The organic phase can subsequently be separated, dried and then filtered, before being concentrated, in particular under reduced pressure.

According to another preferred mode, the base)(B°) and/or (B¹) is used in a stoichiometric amount relative to the amount of acid released by the reaction.

The base (B°) or the base (B¹) is preferably selected from inorganic bases, preferably from the group consisting of: carbonates, phosphates (in particular K₂HPO₄), borates and sodium hydroxide, and mixtures thereof.

According to one optional but nevertheless advantageous arrangement of the invention, the reaction medium comprises at least one organic adjuvant (A°), preferably selected from organic bases, more preferably again from nitrogenous bases and even more preferably from those of which the pKₐ is less than the pH of the aqueous phase.

These adjuvants (A°) can have in particular the function of even further improving the quality of the final product.

These adjuvants (A°) are advantageously organic compounds.

More preferably again, the organic adjuvant (A°) is selected from organic bases, more preferably again from nitrogenous bases and even more preferably from those of which the pKₐ is less than the pH of the aqueous phase.

For example, pyridine, the pKₐ of which is 5, can be advantageously selected in the case of the use of an aqueous phase having a pH of approximately 7.

The adjuvant (A°) can be more specifically selected from the group consisting of pyridine, quinoline, and derivatives of nicotinate or isonicotinate type, and mixtures thereof.

The adjuvant (A°) may be present in an (A°)/(II) molar ratio of preferably between 1×10⁻⁴ and 2, in particular between 1×10⁻² and 1.0.

This optional addition of adjuvant(s) (A°) to the reaction medium can be envisioned irrespective of the oxidizing agent Ox1, Ox2, Ox3 or Ox4. However, when one or more oxidizing agents Ox1 (in particular bleach) is (are) used, it may also be particularly advantageous to add a catalytic amount of at least one auxiliary agent, preferably selected from alkali metal salts, alkali metal bromides being more especially desired.

It is then preferable to employ the auxiliary agent at an (A°)/auxiliary agent ratio of between 0.1 and 2.0, in particular approximately equal to 1.

By way of nonlimiting illustration, steps A and B can be described in detail as follows.

Step A:
Optional setting up of an inert atmosphere in the reaction chamber.
Putting to use the precursor hydrazo derivative of formula (V) and the solvent, at ambient temperature in the reactor.
Stirring at several hundred rpm and heating to a temperature of between 40 and 100° C.
Addition of the precursor silane of formula (IV) over several tens of minutes.
Reaction for several minutes to several hours with stirring at a temperature of between 40 and 100° C., preferably until complete consumption of the precursor silane (IV).
Return to the temperature at which step B should be carried out, preferably using cooling means.

Step B:
Optional setting up of an inert atmosphere in the reaction chamber.
Addition of the aqueous phase comprising aqueous buffer and/or water and/or adjuvant (A°) and, optionally, if steps A and B are linked together, addition of (B°) and/or of (B¹), at ambient temperature, to the reactor, under an inert atmosphere.
Addition of the oxidizing agent (Ox) and, optionally, of (B°) and/or of (B¹) to the reactor, preferably simultaneously, in small amounts (in particular dropwise) and very slowly (a few minutes to several hours, for example over 0.5-2 hours), at a temperature below 30° C., preferably below 5° C.
Stirring at ambient temperature for several hours.
Regulation of the pH of the aqueous phase between 3 and 11, in particular between 5 and 9.
Extraction of the aqueous phase and combining together of the organic phase.
Separation of the organic phase.
Optionally, drying.
Optionally, filtration.
Concentration.
Recovery of the organosilicon compounds comprising an activated azo group (I).

It should be noted that, before the extraction of the aqueous phase, the two-phase reaction medium of the method in accordance with the invention can, for example, be in the form of an emulsion of organic phase in the aqueous phase. The organosilicon compound comprising an activated azo group (I) obtained is advantageously essentially, or even exclusively, present in the organic phase.

In accordance with one particular embodiment, enabling the optimization of the purity of the final organosilicon product (I), a post-treatment in one or more steps is proposed, which makes it possible to significantly improve the quality of the final product (I), by contributing to the complete or virtually complete elimination of residues, without this affecting the yield and/or the productivity with respect to final product (I).

This purification post-treatment consists in recovering the organosilicon compounds of formula (I) obtained, this recovery comprising at least one separation of the organic phase, optionally at least one filtration and/or at least one concentration of the separated organic phase.

Even more preferably, the post-treatment consists essentially:
a) in mixing a chemical affinity support, preferably carbon black, with an organic solution of organosilicon compounds (I), in a proportion of from 0.1% to 20% by weight, preferably in a proportion of from 1% to 10% by weight, of ion affinity support relative to the compounds (I),
b) in leaving in contact, preferably with stirring, for a few minutes to several hours,
c) in separating the support loaded with impurities from the solution of organosilicon compounds (I), preferably by filtration,
d) in eliminating the solvent, preferably by evaporation,
e) in mixing an ion affinity support, preferably a resin which is acid in nature (advantageously a slightly acid resin of the IR50 type), with an organic solution of the loading agent, in a proportion of from 0.01% to 10% by weight, preferably in a proportion of from 0.1% to 5% by weight, of chemical affinity support relative to the organosilicon compounds (I),
f) in leaving in contact, preferably with stirring, for a few minutes to several hours,
g) in separating the impurity-loaded support from the solution of organosilicon compounds (I), preferably by filtration,
h) in eliminating the solvent, preferably by evaporation,
   it being possible for steps e) to h) to be optionally carried out before steps a) to d) or simultaneously.

In fact, steps a) to d) constitute one treatment and steps e) to h) another treatment; these two treatments can be carried out successively in any order, or simultaneously.

In addition, it is not out of the question for the post-treatment implemented in the method according to the invention to comprise only one of these two treatments a) to d), on the one hand, and e) to h), on the other hand.

As indicated above, the organo silicon compounds (I) comprising one or more activated azo functional group(s) (I) obtained (directly) by means of the method according to the invention are advantageously free or virtually free (undetectable traces) of impurities, in particular of pyridine residues.

The invention is therefore also directed toward, as new products, organosilicon compounds (I) comprising one or more activated azo functional group(s) (I), preferably obtained (directly) by means of the method according to the invention, characterized in that they are free or virtually free (undetectable traces) of impurities, in particular of pyridine residues.

These organosilicon compounds (I) comprising one or more activated azo functional group(s) (I), preferably obtained (directly) by means of the method according to the invention, are advantageously heat-stable, in particular stable at temperatures of between 80 and 180° C.

Moreover, the various groups contained in formula (I) described above may be as follows. For example, the linear alkyl groups may be methyl, ethyl, propyl, isopropyl, n-butyl, isobutyl, t-butyl, pentyl, isopentyl, neopentyl, 2-methylbutyl, 1-ethylpropyl, hexyl, isohexyl, neohexyl, 1-methylpentyl, 3-methylpentyl, 1,1-dimethylbutyl, 1,3-dimethylbutyl, 2-ethylbutyl, 1-methyl-1-ethylpropyl, heptyl, 1-methylhexyl, 1-propylbutyl, 4,4-dimethylpentyl, octyl, 1-methylheptyl, 2-ethylhexyl, 5,5-dimethylhexyl, nonyl, decyl, 1-methylnonyl, 3,7-dimethyloctyl, 7,7-dimethyloctyl and hexadecyl radicals.

The cyclic alkyl groups may be in particular cyclopentyl, cyclohexyl, cycloheptyl, cyclooctyl, adamantyl or norbornyl radicals.

For example, the aryl groups may be phenyl, naphthyl, anthryl and phenanthryl radicals.

The arylalkyl groups may be in particular benzyl radicals.

For example, the alkylaryl radicals may be tolyl radicals.

The substituents of the abovementioned groups are, for example, alkoxy groups in which the alkyl part is preferably as defined above.

For example, the cyclic groups may be in particular imidazole, pyrazole, pyrrolidine, Δ2-pyrroline, imidazolidine, Δ2-imidazoline, pyrazolidine, Δ3-pyrazoline, piperidine; preferred examples are pyrrole, imidazole and pyrazole.

For example, in formula (I), X¹ corresponds to —NH— and Z corresponds to -n-C₃H₆—Si(OCH₂CH₃)₃, but without excluding alkyl linking groups containing 2, 4 or 5 carbons, or alkoxys containing 1, 3 or 4 carbons, inter alia, which are substituted or unsubstituted.

As examples of hydrazosilane intermediate compounds (II) of the method as defined above, mention may in particular be made of the following products:

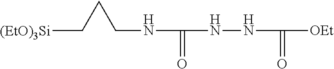

(C₂H₅O)₃Si—(CH₂)₃—NH—CO—NH—NH—COOCH₃
(CH₃O)₃Si—(CH₂)₃—NH—CO—NH—NH—COOC₂H₅
(n-C₄H₉O)₃Si—(CH₂)₃—NH—CO—NH—NH—COOC₂H₅
(C₂H₅O)₂(Me₃SiO)Si—(CH₂)₃—NH—CO—NH—NH—COOC₂H₅
(C₂H₅O)₂(Me₃SiO)Si—(CH₂)₃—NH—CO—NH—NH—COOCH₃
(CH₃O)₂ (Me₃SiO)Si—(CH₂)₃—NH—CO—NH—NH—COOC₂H₅
(n-C₄H₉O)₂(Me₃SiO)Si—(CH₂)₃—NH—CO—NH—NH—COOC₂H₅
(C₂H₅O)₂MeSi—(CH₂)₃—NH—CO—NH—NH—COOC₂H₅
(C₂H₅O)Me₂Si—(CH₂)₃—NH—CO—NH—NH—COOC₂H₅
   As examples of azosilane organosilicon compounds, mention may in particular be made of the following products:

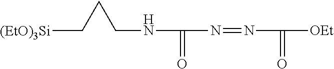

(C₂H₅O)₃Si—(CH₂)₃—NH—CO—N═N—COOCH₃
(CH₃O)₃Si—(CH₂)₃—NH—CO—N═N—COOC₂H₅
(n-C₄H₉O)₃Si—(CH₂)₃—NH—CO—N═N—COOC₂H₅
(C₂H₅O)₂(Me₃SiO)Si—(CH₂)₃—NH—CO—N═N—COOC₂H₅
(C₂H₅O)₂ (Me₃SiO)Si—(CH₂)₃—NH—CO—N═N—COOCH₃
(CH₃O)₂ (Me₃SiO)Si—(CH₂)₃—NH—CO—N═N—COOC₂H₅
(n-C₄H₉O)₂ (Me₃SiO)Si—(CH₂)₃—NH—CO—N═N—COOC₂H₅
(C₂H₅O)₂MeSi—(CH₂)₃—NH—CO—N═N—COOC₂H₅
(C₂H₅O)Me₂Si—(CH₂)₃—NH—CO—N═N—COOC₂H₅

The compounds according to the invention preferably comprise at least one of the abovementioned compounds.

The following examples illustrate the invention without, however, limiting the scope thereof.

The reaction scheme of the method exemplified comprises steps A and B linked together without isolation of the precursor (II).

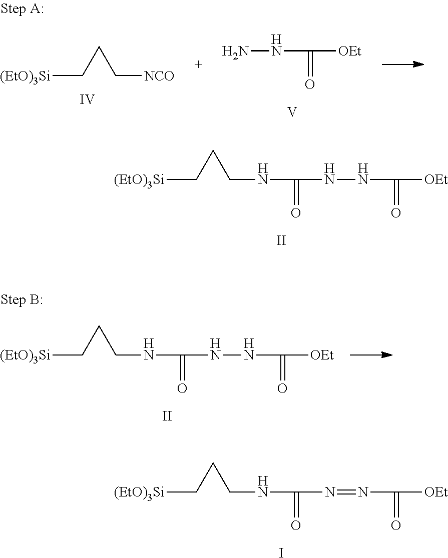

### EXAMPLES

### Description of the Material Used

The reactor is a jacketed glass reactor with a 10 liter capacity, surmounted by a water cooler and equipped with mechanical stirring.

The filtrations of stage 1, when it should be isolated, are carried out on a Büchner filter (polypropylene cloth) (vacuum of approximately 15-20 mbar).

### Example with Isolation of the Intermediate (II)

### Batchwise Test

### Synthesis and Isolation of the Intermediate (II)

### Step A

Rendering the reactor inert with nitrogen.
Loading molten ethyl carbazate (V) (1087 g, 10.2 mol) (oven at 60° C.).
Loading toluene (4967 g).
Starting the stirring (120-130 rpm).
Heating the reaction medium to a temperature of 60° C.
Adding 3-isocyanatotriethoxysilane (IV) (2659 g, 10.3 mol) by means of a metering pump. The speed of addition is adjusted such that the temperature of the reaction medium does not exceed +60° C.
Maintaining the jacket temperature at 60° C. until the starting 3-isocyanatotriethoxysilane (IV) has completely disappeared.
Cooling the temperature of the MR to +20° C.
Filtering the solid (polypropylene cloth).
Loading rinsing toluene (1972 g) into the reactor.
Washing the filtration cake.
Drying the filtration cake until the loss on desiccation, measured with a thermobalance, represents 5%.
The intermediate hydrazo derivative (II) is recovered (3512 g, 10 mol) with a yield of 98%.

### Synthesis of the Azo (I)

### Step B

Rendering the reactor inert with nitrogen.
Loading the intermediate hydrazo derivative (II) previously isolated (1855 g, 5.01 mol).
Loading the toluene (2670 g).
Loading the buffer solution, pH 5 (1489 g).
Loading the sodium bromide (26.8 g, 0.26 mol).
Loading the pyridine (20.3 g, 0.26 mol).
Starting the stirring (120-130 rpm).
Adjusting the temperature of the reaction medium to −2° C.
Loading the 13% bleach (3526 g, 6.16 mol), by means of a metering pump, into the mass such that the temperature of the reaction medium does not exceed +2° C.
Maintaining the jacket temperature at −2° C. for 30 minutes.
Adjusting the jacket temperature to +20° C.
Measuring the pH of the aqueous phase and adjusting it to 7-8 (if it is above 8) by adding HCl (5% w/w).
Stopping the stirring and leaving to settle out (approximately 30 minutes).
Removing the upper (toluene) phase by suction.
Loading toluene (2800 g).
Starting the stirring (120-130 rpm) and maintaining for approximately 30 minutes.
Stopping the stirring and leaving to settle out (approximately 30 minutes).
Removing the upper (toluene) phase by suction.
Draining and discharging the aqueous phase.
The combined organic phases are dried by adding anhydrous magnesium sulfate (200 g).
Filtering off the magnesium sulfate under a nitrogen pressure and linen cardboard.
The toluene is evaporated off under vacuum.
The desired azo derivative (I) is then recovered (1484 g, 4.3 mol) with a yield of 85% and a purity of 94.7% w/w.

The overall yield over these two steps with isolation of the hydrazo intermediate is therefore equal to 0.98×0.85, i.e. 83%.

### Example without Isolation of the Intermediate (II)

### Continuous Test

Rendering the reactor inert with nitrogen.
Loading the molten ethyl carbazate (V) (537 g, 5.04 mol) (oven at 60° C.).
Loading the toluene (2427 g).
Starting the stirring (120-130 rpm).
Heating the reaction medium to the temperature of 60° C.
Adding 3-isocyanatotriethoxysilane (IV) (1281 g, 4.96 mol) by means of a metering pump. The speed of addition is adjusted such that the temperature of the reaction medium does not exceed +60° C.
Maintaining the jacket temperature at 60° C. until the starting 3-isocyanatotriethoxysilane (IV) has completely disappeared.
Cooling the temperature of the MR to +20° C.
Loading the buffer solution, pH 5 (1444 g).
Loading the sodium bromide (26 g, 0.25 mol).
Loading the pyridine (19 g, 0.24 mol).
Starting the stirring (120-130 rpm).
Adjusting the temperature of the reaction medium to −2° C.
Loading the 13% bleach (3444 g, 6.02 mol), by means of a metering pump, into the mass such that the temperature of the reaction medium does not exceed +2° C.
Maintaining the jacket temperature at −2° C. for 30 minutes.
Adjusting the jacket temperature to +20° C.
Measuring the pH of the aqueous phase and adjusting it to 7-8 (if it is above 8) by adding HCl (5% w/w).
Stopping the stirring and leaving to settle out (approximately 30 minutes).
Removing the upper (toluene) phase by suction.
Loading toluene (2920 g).
Starting the stirring (120-130 rpm) and maintaining for approximately 30 minutes.
Stopping the stirring and leaving to settle out (approximately 30 minutes).
Removing the upper (toluene) phase by suction.
Draining and discharging the aqueous phase.
The combined organic phases are dried by adding anhydrous magnesium sulfate (210 g).
Filtering the magnesium sulfate under a nitrogen pressure and linen cardboard.
The toluene is evaporated off under vacuum.

The desired azo derivative (I), is then recovered (1522 g, 4.35 mol) with a yield of 88% and a purity of 94.7% w/w.

1-16. (canceled)

17. A method for the preparation of at least one azosilane-functionalized organosilicon compound having the formula (I):
Y—X—CO—N═N—CO—X¹—Z (I)
in which:
X is an amine group —NR°, wherein R° is a hydrogen atom, a linear, branched or cyclic alkyl radical having from 1 to 20 carbon atoms, an aryl radical having from 6 to 18 carbon atoms, or an arylalkyl or alkylaryl radical (C₆-C₁₈ aryl, C₁-C₂₀ alkyl), such alkyl, aryl, arylalkyl or alkylaryl radical being substituted or unsubstituted,
an oxygen atom,
a sulfur atom,
a covalent bond,
or a substituted or unsubstituted, linear, branched or cyclic alkylene radical having from 1 to 20 carbon atoms;
X¹ is an amine group —NR°, wherein R° is a hydrogen atom, a linear, branched or cyclic alkyl radical having from 1 to 20 carbon atoms, an aryl radical having from 6 to 18 carbon atoms, or an aralkyl radical (C₆-C₁₈ aryl, C₁-C₂₀ alkyl), such alkyl, aryl or aralkyl radical being substituted or unsubstituted,
an oxygen atom,
a sulfur atom,
or a substituted or unsubstituted, linear, branched or cyclic alkylene radical having from 1 to 20 carbon atoms;
Y is a linear, branched or cyclic alkyl radical having from 1 to 20 carbon atoms, an aryl radical having from 6 to 18 carbon atoms, or an arylalkyl or alkylaryl radical (C₆-C₁₈ aryl, C₁-C₂₀ alkyl), such alkyl, aryl, arylalkyl or alkylaryl radical being substituted or unsubstituted or being identical to Z and optionally bearing at least one heteroatom; and
Z is a linear, branched or cyclic alkyl radical having from 1 to 20 carbon atoms, an aryl radical having from 6 to 18 carbon atoms, or an arylalkyl or alkylaryl radical (C₆-C₁₈ aryl, C₁-C₂₀ alkyl), such alkyl, aryl, arylalkyl or alkylaryl radical being substituted with at least one polyorganosiloxane group and/or at least one silane group of formula:
—SiR¹ₐ(OR²)_{b}(OSiR³R⁴R⁵)_{c}
in which:
a, b and c are integers selected such that a+b+c=3;
R¹, R², R³, R⁴ and R⁵ are, independently, a linear, branched or cyclic alkyl radical having from 1 to 20 carbon atoms, an aryl radical having from 6 to 18 carbon atoms, or an arylalkyl or alkylaryl radical (C₆-C₁₈ aryl, C₁-C₂₀ alkyl), such alkyl, aryl, arylalkyl or alkylaryl group being substituted or unsubstituted and optionally bearing at least one heteroatom, and at least one of Y and/or Z being substituted with said at least one polyorganosiloxane group and/or at least one such silane group; said method comprising;
A. reacting at least one precursor silane of formula (IV):
Z-L¹ (IV)
with at least one precursor hydrazo compound of formula (V):
L²-NH—NH—CO—X—Y (V)
in which formulae:
L¹ and L² are radicals, the structure and the functionality of which are such that these radicals react with one another to provide the functions —Z—X¹—CO— in such manner as to produce the compounds of formula (II), which are precursors of the compounds (I):
Y—X—CO—NH—NH—CO—X¹—Z (II)
and B. then oxidizing the hydrazino group of the precursors (II) to an azo group specific to the organosilicon compounds comprising one or more activated azo group(s) (I), employing an oxidizing system which comprises at least one oxidizing agent (Ox) and at least one base (B), this oxidation being carried out in an aqueous/organic two-phase medium, the pH of the aqueous phase ranging from 3 to 11; wherein said oxidation step B is carried out directly on the reaction medium obtained at the end of step A and containing said precursors (II).

18. The method as defined by claim 17, wherein steps A and B are linked together.

19. The method as defined by claim 17, wherein the precursors (II) produced at the end of step A are not isolated from the reaction medium obtained at the end of step A.

20. The method as defined by claim 17, wherein, in step B, the pH of the aqueous phase ranges from 5 to 9.

21. The method as defined by claim 17, wherein the oxidizing agent (Ox) is selected from among oxidizing agents capable of oxidizing a hydrazine function to an azo function and selected from the group consisting of:
(Ox1): aqueous halogenated oxidizing agents, sodium hypobromite (NaOBr) and/or sodium hypochlorite (NaOCl) and/or tert-butyl hypochlorite;
(Ox2): anhydrous halogenated oxidizing agents, Cl₂ and/or Br₂ and/or N-bromosuccinimide and/or cyanide-containing halogenated compounds, trichloroisocyanuric acid;
(Ox3): all other oxidizing agents different than (Ox1) and than (Ox2), aqueous hydrogen peroxide solutions; and
(Ox4): mixtures thereof.

22. The method as defined by claim 17, wherein the oxidizing agent (Ox) is Ox1, and the base (B) is formed from Ox1 as soon as the latter is in aqueous solution.

23. The method as defined by claim 17, wherein the reaction medium comprises at least one organic adjuvant (A°), optionally those of which the pKₐ is less than the pH of the aqueous phase.

24. The method as defined by claim 17, wherein one or more Ox1 oxidants are employed and wherein at least one auxiliary agent is also added to the reaction medium, optionally at an (A°)/auxiliary agent ratio of from 0.1 to 2.0.

25. The method as defined by claim 17, wherein the organosilicon compound(s) (I) obtained is (are) subjected to a purification post-treatment.

26. The method as defined by claim 17, wherein the organosilicon compound(s) (I) obtained is (are) recovered, such recovery comprising at least one separation of an organic phase, optionally at least one filtration and/or at least one concentration of the separated organic phase.

27. The method as defined by claim 17, wherein, in formula (I), X¹ corresponds to —NH— and Z corresponds to -n-C₃H₆—Si(OCH₂CH₃)₃.

28. The method as defined by claim 17, wherein the azosilane-functionalized organosilicon compounds are selected from the group consisting of the following compounds:
(C₂H₅O)₃Si—(CH₂)₃—NH—CO—N═N—COOCH₃
(CH₃O)₃Si—(CH₂)₃—NH—CO—N═N—COOC₂H₅
(n-C₄H₆O)₃Si—(CH₂)₃—NH—CO—N═N—COOC₂H₅
(C₂H₆O)₂(Me₃SiO)Si—(CH₂)₃—NH—CO—N═N—COOC₂H₅
(C₂H₅O)₂(Me₃SiO)Si—(CH₂)₃—NH—CO—N═N—COOCH₃
(CH₃O)₂ (Me₃SiO)Si—(CH₂)₃—NH—CO—N═N—COOC₂H₅
(n-C₄H₆O)₂ (Me₃SiO)Si—(CH₂)₃—NH—CO—N═N—COOC₂H₅
(C₂H₅O)₂MeSi—(CH₂)₃—NH—CO—N═N—COOC₂H₅
(C₂H₅O)Me₂Si—(CH₂)₃—NH—CO—N═N—COOC₂H₅.

29. An azosilane-functionalized organosilicon compound having the formula (I):
Y—X—CO—N═N—CO—X¹—Z (I)
in which:
X is an amine group —NR°, wherein R° is a hydrogen atom, a linear, branched or cyclic alkyl radical having from 1 to 20 carbon atoms, an aryl radical having from 6 to 18 carbon atoms, or an arylalkyl or alkylaryl radical (C₆-C₁₈ aryl, C₁-C₂₀ alkyl), such alkyl, aryl, arylalkyl or alkylaryl radical being substituted or unsubstituted,
an oxygen atom,
a sulfur atom,
a covalent bond,
or a substituted or unsubstituted, linear, branched or cyclic alkylene radical having from 1 to 20 carbon atoms;
X¹ is an amine group —NR°, wherein R° is a hydrogen atom, a linear, branched or cyclic alkyl radical having from 1 to 20 carbon atoms, an aryl radical having from 6 to 18 carbon atoms, or an aralkyl radical (C₆-C₁₈ aryl, C₁-C₂₀ alkyl), such alkyl, aryl or aralkyl radical being substituted or unsubstituted,
an oxygen atom,
a sulfur atom,
or a substituted or unsubstituted, linear, branched or cyclic alkylene radical containing from 1 to 20 carbon atoms;
Y is a linear, branched or cyclic alkyl radical having from 1 to 20 carbon atoms, an aryl radical having from 6 to 18 carbon atoms, or an arylalkyl or alkylaryl radical (C₆-C₁₈ aryl, C₁-C₂₀ alkyl), such alkyl, aryl, arylalkyl or alkylaryl radical being substituted or unsubstituted and optionally being identical to Z and optionally bearing at least one heteroatom; and
Z is a linear, branched or cyclic alkyl radical having from 1 to 20 carbon atoms, an aryl radical having from 6 to 18 carbon atoms, or an arylalkyl or alkylaryl radical (C₆-C₁₈ aryl, C₁-C₂₀ alkyl), such alkyl, aryl, arylalkyl or alkylaryl radical being unsubstituted or substituted with at least one polyorganosiloxane group and/or at least one silane group of formula:
—SiR¹ₐ(OR²)_{b}(OSiR³R⁴R)_{c}
in which:
a, b and c are integers selected such that a+b+c=3;
R¹, R², R³, R⁴ and R⁵ are, independently, a linear, branched or cyclic alkyl radical having from 1 to 20 carbon atoms, an aryl radical having from 6 to 18 carbon atoms, or an arylalkyl or alkylaryl radical (C₆-C₁₈ aryl, C₁-C₂₀ alkyl), such alkyl, aryl, arylalkyl or alkylaryl radical being substituted or unsubstituted and optionally bearing at least one heteroatom; and at least one of Y and/or Z being substituted with said at least one polyorganosiloxane group and/or at least one such silane group.

30. An organosilicon compound as defined by claim 29, being heat-stable at temperatures ranging from 80 to 180° C.

31. An organosilicon compound as defined by claim 29, wherein, in formula (I), X¹ corresponds to —NH— and Z corresponds to -n-C₃H₆—Si(OCH₂CH₃)₃.

32. An organosilicon compound as defined by claim 31, selected from the group consisting of at least one of the following compounds:
(C₂H₅O)₃Si—(CH₂)₃—NH—CO—N═N—COOCH₃
(CH₃O)₃Si—(CH₂)₃—NH—CO—N═N—COOC₂H₅
(n-C₄H₉O)₃Si—(CH₂)₃—NH—CO—N═N—COOC₂H₅
(C₂H₅O)₂(Me₃SiO)Si—(CH₂)₃—NH—CO—N═N—COOC₂H₅
(C₂H₅O)₂ (Me₃SiO)Si—(CH₂)₃—NH—CO—N═N—COOCH₃
(CH₃O)₂ (Me₃SiO)Si—(CH₂)₃—NH—CO—N═N—COOC₂H₅
(n-C₄H₉O)₂(Me₃SiO)Si—(CH₂)₃—NH—CO—N═N—COOC₂H₅
(C₂H₅O)₂MeSi—(CH₂)₃—NH—CO—N═N—COOC₂H₅
(C₂H₅O)Me₂Si—(CH₂)₃—NH—CO—N═N—COOC₂H₅.

33. An organosilicon compound as defined by claim 29, free or virtually free of impurities.
